(19) United States
(12) Patent Application Publication
(10) Pub. No.: US 2019/0351903 A1
(43) Pub. Date: Nov. 21, 2019

(54) CONFIRMATION AND MITIGATION OF SENSOR MALFUNCTION IN ADAPTIVE CRUISE CONTROL

(71) Applicant: GM Global Technology Operations LLC, Detroit, MI (US)

(72) Inventors: Ming Zhao, Northville, MI (US); Tao Yu, Bloomfield Hills, MI (US); Corey A. Pickering, Brighton, MI (US)

(21) Appl. No.: 15/984,733

(22) Filed: May 21, 2018

(51) Int. Cl. B60W 30/14

(52) U.S. Cl. CPC B60W 30/14; B60W 2050/021

(57) ABSTRACT

A system and method to confirm and mitigate a malfunction of a sensor used for adaptive cruise control (ACC) in a vehicle involve identifying the malfunction of the sensor. The method also includes determining a counter threshold value that defines a duration for which recovery of the sensor is awaited, and performing an iterative process to determine if the sensor has recovered. A number of iterations of the iterative process is determined by the counter threshold value. The method also includes confirming the malfunction of the sensor based on the number of iterations exceeding the counter threshold value without a determination that the sensor has recovered, and inhibiting the ACC based on the confirming the malfunction.

### INTRODUCTION

The subject disclosure relates to confirmation and mitigation of sensor malfunction in Adaptive Cruise Control (ACC).

In vehicles (e.g., automobiles, trucks), ACC refers to a vehicle system that generally maintains a constant speed set by the driver. In prior cruise control systems, a constant speed was maintained regardless of the situation encountered by the vehicle, referred to as the host vehicle, such that a driver had to be alert for situations (e.g., approaching a slower car) that required a change from that constant speed. ACC includes the ability to brake or slow the vehicle, as needed, followed by acceleration back to the set speed. ACC relies on sensors (e.g., radar system, camera, lidar system, microphone) that detect objects (e.g., another vehicle) ahead of the host vehicle. An object detected by a sensor may unexpectedly stop being detected. Accordingly, it is desirable to provide confirmation and mitigation of sensor malfunction in ACC.

### SUMMARY

In one exemplary embodiment, a method of confirming and mitigating a malfunction of a sensor used for adaptive cruise control (ACC) in a vehicle includes identifying the malfunction of the sensor, and determining a counter threshold value that defines a duration for which recovery of the sensor is awaited. An iterative process is performed to determine if the sensor has recovered. A number of iterations of the iterative process is determined by the counter threshold value. The method also includes confirming the malfunction of the sensor based on the number of iterations exceeding the counter threshold value without a determination that the sensor has recovered, and inhibiting the ACC based on the confirming the malfunction.

In addition to one or more of the features described herein, the method also includes resuming the ACC based on determining that the sensor has recovered prior to the number of iterations exceeding the counter threshold value.

In addition to one or more of the features described herein, the method also includes resuming the ACC based on determining that the sensor has recovered after the number of iterations exceeds the counter threshold value.

In addition to one or more of the features described herein, the method also includes disabling acceleration of the vehicle as part of the ACC prior to performing the iterative process.

In addition to one or more of the features described herein, the determining the counter threshold value is based on whether the vehicle was braking when the malfunction of the sensor was identified.

In addition to one or more of the features described herein, the determining the counter threshold value is based on a distance between the vehicle and a target vehicle in front of the vehicle when the malfunction of the sensor was identified.

In addition to one or more of the features described herein, the determining the counter threshold value is based on a speed of the vehicle when the malfunction of the sensor was identified.

In addition to one or more of the features described herein, the method also includes performing a second iterative process to determine if the sensor has recovered, wherein a number of iterations of the second iterative process is determined based on a speed of the vehicle when the malfunction of the sensor was identified.

In addition to one or more of the features described herein, the method also includes ending inhibition of the ACC based on the sensor recovering during the second iterative process.

In addition to one or more of the features described herein, the method also includes ending inhibition of the ACC based on the second iterative process ending.

In another exemplary embodiment, a system to confirm and mitigate a malfunction of a sensor used for adaptive cruise control (ACC) in a vehicle includes the sensor to detect an object in front of the vehicle. A processor identifies the malfunction of the sensor, determines a counter threshold value that defines a duration for which recovery of the sensor is awaited, and performs an iterative process to determine if the sensor has recovered. A number of iterations of the iterative process is determined by the counter threshold value. The processor also confirms the malfunction of the sensor based on the number of iterations exceeding the counter threshold value without a determination that the sensor has recovered, and inhibits the ACC based on confirming the malfunction.

In addition to one or more of the features described herein, the processor resumes the ACC based on determining that the sensor has recovered prior to the number of iterations exceeding the counter threshold value.

In addition to one or more of the features described herein, the processor resumes the ACC based on determining that the sensor has recovered after the number of iterations exceeds the counter threshold value.

In addition to one or more of the features described herein, the processor disables acceleration of the vehicle as part of the ACC prior to performing the iterative process.

In addition to one or more of the features described herein, the processor determines the counter threshold value based on whether the vehicle was braking when the malfunction of the sensor was identified.

In addition to one or more of the features described herein, the processor determines the counter threshold value based on a distance between the vehicle and a target vehicle in front of the vehicle when the malfunction of the sensor was identified.

In addition to one or more of the features described herein, the processor determines the counter threshold value based on a speed of the vehicle when the malfunction of the sensor was identified.

In addition to one or more of the features described herein, the processor performs a second iterative process to determine if the sensor has recovered and determine a number of iterations of the second iterative process based on a speed of the vehicle when the malfunction of the sensor was identified.

In addition to one or more of the features described herein, the processor ends inhibition of the ACC based on the sensor recovering during the second iterative process or based on the second iterative process ending.

In addition to one or more of the features described herein, the sensor is a camera.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an exemplary scenario involving confirmation and mitigation of sensor malfunction in adaptive cruise control according to one or more embodiments;

FIG. 2 is a process flow of a method of confirming sensor malfunction according to one or more embodiments;

FIG. 3 is a process flow of a method of mitigating sensor malfunction according to one or more embodiments; and

FIG. 4 indicates the factors that are considered in the determination of the threshold used in the conformation of a sensor malfunction according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, ACC is a vehicle system that uses sensor information to brake or slow the host vehicle, as needed, rather than maintaining the set constant speed regardless of objects such as other vehicles in the way of the host vehicle. When an object detected by the sensor, also referred to as a target of the sensor, is unexpectedly out of sensor view, a prior approach may be to immediately disengage ACC and resume driver control of the host vehicle. This approach ensures safety during a potential malfunction in the sensor. However, if this scenario happens frequently or the sensor recovers almost immediately, the driver is unnecessarily inconvenienced by having to take over vehicle operation.

Embodiments of the systems and methods detailed herein relate to providing confirmation and mitigation of sensor malfunction in ACC. A camera is specifically discussed as the sensor used to control the ACC for explanatory purposes, but the processes described apply, as well, to other forward-looking sensors. In the case of a camera, an unexpected target drop refers to a target (e.g., vehicle) appearing in a camera image (also referred to as a frame) then disappearing in a consecutive image without a discernable reason (e.g., turn, lane change). This situation is recognized as being different from a vehicle that makes a turn or changes lanes to leave the camera field of view. During a target drop scenario, embodiments detailed herein balance the safest reaction, which is to immediately return vehicle control to the driver, with the most convenient reaction, which is to delay disabling of ACC functionality until driver intervention is absolutely necessary. Specifically, one or more embodiments determine a proper period during which recovery of the sensor may be considered before disabling ACC functionality, as detailed.

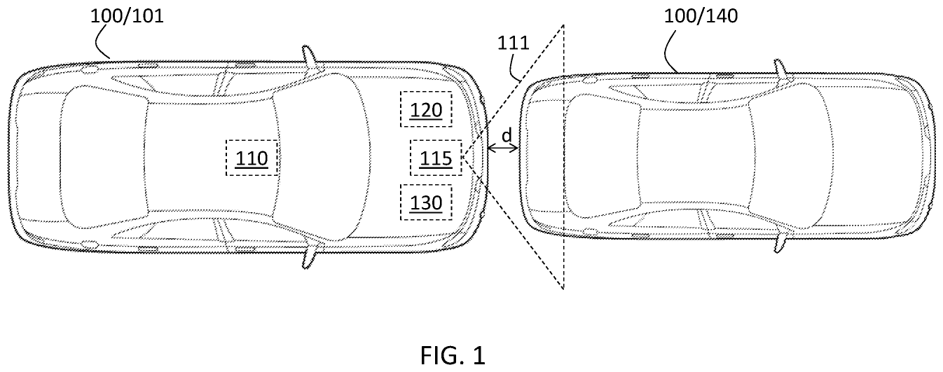

In accordance with an exemplary embodiment, FIG. 1 illustrates an exemplary scenario involving confirmation and mitigation of sensor malfunction in ACC. The exemplary vehicle 100 shown in FIG. 1 is an automobile and is referred to as the host vehicle 101 for explanatory purposes. Another vehicle 100 is in front of the host vehicle 101 and is referred to as the target 140. The distance d indicates the following distance of the host vehicle 101 behind the target 140. The host vehicle 101 includes a front-facing camera 110 with the field of view 111 indicated in FIG. 1. While the camera 110 is shown in the passenger compartment in FIG. 1 as an exemplary location, the camera 110 may be located elsewhere in or on the host vehicle 101 (e.g., attached behind the rear view mirror). The host vehicle 101 may also include other sensors 115 (e.g., radar system, lidar system) which may also be located anywhere in or on the host vehicle 101. A processing module 120 may obtain and process images from the camera 110. The processing module 120 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The host vehicle 101 also includes a vehicle controller 130 (e.g., electronic control unit (ECU)) that implements the ACC functionality. The vehicle controller 130, alone or in combination with other controllers, may augment or automate other vehicle functions (e.g., automatic braking, collision avoidance). In alternate embodiments, the processing module 120 that processes information from the camera 110 and other sensors 115 may be part of the vehicle controller 130.

When the camera 110 is functioning as expected, the target 140 is detected in images obtained by the camera 110 as long as the target 140 remains in the field of view 111 of the camera 110. If the target 140 makes a turn or changes lanes to leave the field of view of the camera 110, that motion is detected by the processing module 120, and the target 140 is not expected in subsequent images obtained by the camera 110. However, when no such motion has been detected for the target 140 but the target 140 is no longer in images obtained by the camera 110, a determination must be made as to whether the camera 110 has recovered or not so that ACC may be properly disabled. That is, according to one or more embodiments, confirmation of the target drop is sought prior to disabling ACC functionality rather than disabling ACC functionality as an immediate and automatic reaction to a target drop, as in prior approaches. According to embodiments detailed herein, the time period during which recovery of the camera 110 is considered is set dynamically based on factors prior to the target 140 being dropped.

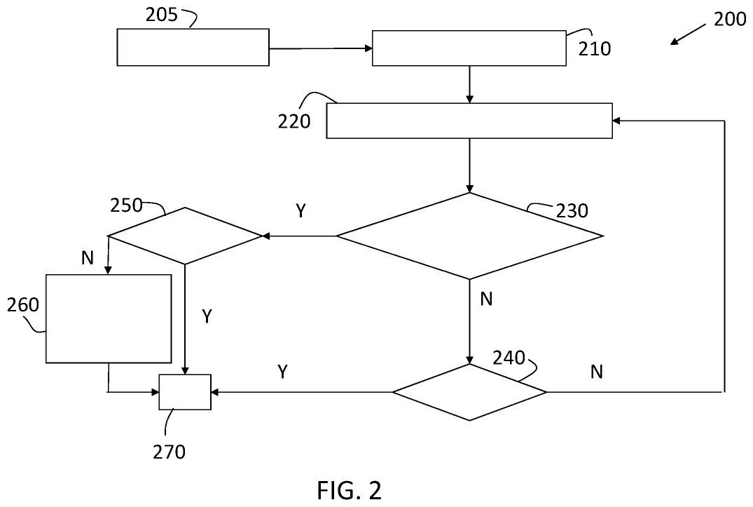

FIG. 2 is a process flow 200 of a method of confirming sensor malfunction according to one or more embodiments. In the exemplary case discussed with reference to FIG. 2, the sensor is the camera 110. The processes of FIG. 2 are performed after the processing module 120 detects a target drop, at block 205, based on images from the camera 110. As previously noted, according to an exemplary embodiment, a target drop is the disappearance of a target 140 from images obtained from the camera 110 without an indication of a turn or lane change that would gradually move the target 140 out of the field of view 111 of the camera 110. At block 210, disabling acceleration refers to preventing the host vehicle 101 from accelerating. As previously noted, if a host vehicle 101 speed had to be decreased from the driver setting due to an obstruction or road condition that was detected, normal operation of in ACC mode would result in an acceleration back to the speed according to the driver setting. The process at block 210 prevents this acceleration when a target drop is detected.

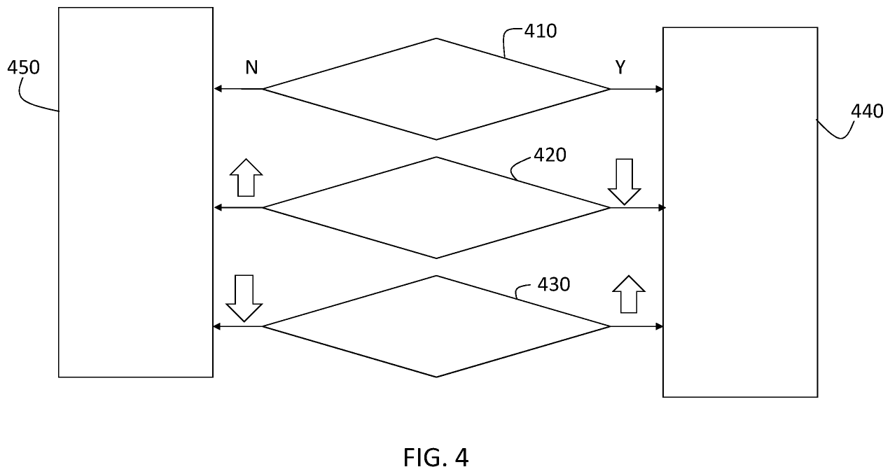

At block 220, initializing or incrementing a counter refers to initializing a counter when the process flow is executed the first time after a target drop is detected. In subsequent iterations, the counter is incremented by one. At block 230, a check is performed of whether the counter exceeds a threshold. The determination of this threshold is a key factor in the embodiments detailed herein and is discussed further with reference to FIG. 4.

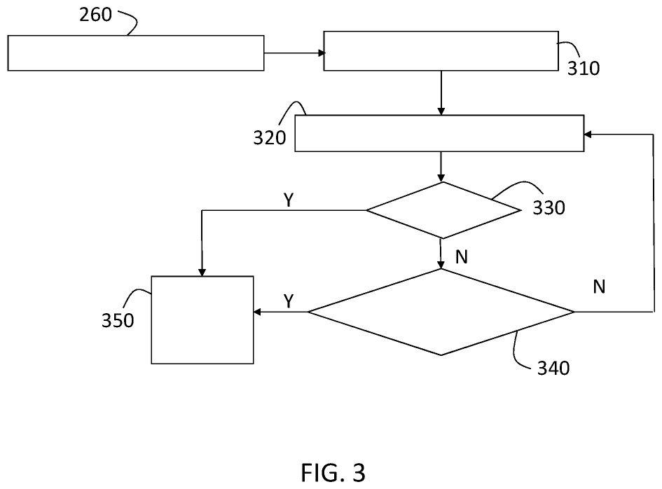

If the counter does not exceed the threshold, according to the check at block 230, then a check is performed, at block 240, of whether the camera 110 has recovered. That is, if the target 140 is once again visible in images obtained from the camera 110 or the camera 110 is otherwise deemed to be operating properly by the processing module 120, then the check at block 240 results in a determination that recovery has occurred. If the check at block 240 indicates recovery of the camera 110, then the processes end, at block 270, without a confirmation that the camera 110 is malfunctioning. In this case, the ACC functionality is not disabled based on processes discussed with reference to FIG. 3 and normal ACC operation is resumed. If the check at block 240 indicates that there has not been a recovery of the camera 110, then the process at block 220 to increment the counter is performed to initiate another iteration.

If the counter does exceed the threshold, according to the check at block 230, then a check is performed, at block 250, of whether the camera 110 has recovered. The check at block 250 is like the check at block 240. If the camera 110 is determined to have recovered, at block 250, then the processes end, at block 270, without a confirmation that the camera 110 is malfunctioning. As discussed previously, normal operation of the ACC is resumed in this case. If the check at block 250 indicates that the camera 110 has not recovered, then confirming sensor malfunction, which is malfunction of the camera 110 in the exemplary case, at block 260, triggers the processes discussed with reference to FIG. 3. As FIG. 2 makes clear, the threshold for the counter is the determinative factor is how long the processing module 120 waits (based on iterating processes 220, 230, and 240) for a recovery of the camera 110 before ACC functionality is disabled (at block 260).

FIG. 3 is a process flow of a method of mitigating sensor malfunction according to one or more embodiments. As FIG. 3 indicates, the processes shown in FIG. 3 begin with a confirmation of sensor malfunction (at block 260, FIG. 2). That is, once the processing module 120 has confirmed sensor malfunction (block 260, FIG. 2), the processes show in FIG. 3 are performed by the processing module 120 or, in alternate embodiments, by the vehicle controller 130. At block 310, inhibiting ACC engagement refers to returning control of the host vehicle 101 to the driver and, additionally, inhibiting the driver from re-engaging ACC functionality. At block 320, a counter is initialized or incremented. The first time this process is encountered after a malfunction confirmation, the counter is initialized. Each subsequent time that the process at block 320 is performed, the counter is incremented. At block 330, a check is done of whether the sensor, the camera 110 in the exemplary case, has recovered. This process is similar to the processes discussed with reference to blocks 240 and 250 in FIG. 2.

If it is determined, based on the check at block 330, that the camera 110 has not recovered, then a check is done, at block 340, of whether the counter exceeds a threshold. This threshold is not the same as the threshold discussed with reference to block 230 (FIG. 2). This threshold may be set based on the speed of the host vehicle 101 when ACC functionality was inhibited (i.e., when control of the host vehicle 101 was returned to the driver). That is, the threshold may be higher, thereby requiring more iterations before ACC functionality is allowed, when the speed of the host vehicle 101 was relatively high (as compared with a defined speed value). On the other hand, the threshold may be lower, thereby resuming ACC functionality with fewer iterations, when the speed of the host vehicle 101 was relative low (relative to the same defined speed value).

If the check, at block 340, indicates that the counter has not exceeded the threshold, then the counter is incremented and another iteration is performed starting at block 320. If the check, at block 340, indicates that the counter has exceeded the threshold, then lifting the inhibition of ACC functionality, at block 350, is performed. If it is determined, based on the check at block 330, that the camera 110 has recovered, then lifting the inhibition of ACC, at block 350, is also reached. Thus, whether the sensor that had malfunctioned has recovered (per the check at block 330) or a certain period, defined by the threshold, has expired (per the check at block 340), inhibition of the ACC is lifted (at block 350) and normal ACC functionality is resumed.

FIG. 4 indicates the factors that are considered in the determination of the threshold used in the confirmation of a sensor malfunction according to one or more embodiments. That is, these factors affect the threshold used in block 230 (FIG. 2). As FIG. 2 indicates, a lower threshold decreases the number of iterations and, thereby, decreases the time within which confirmation of sensor malfunction (at block 260, FIG. 2) is performed. On the other hand, a higher threshold increases the number of iterations. As such, more time is taken to determine if the sensor has recovered before ACC functionality is inhibited.

At block 410, a determination is made of whether the host vehicle 101 was braking when the target drop occurred. If so, then this is a factor that reduces the threshold value, at block 440. This is because the host vehicle 101 braking, under operation of the ACC, prior to the target drop indicates that a target 140 or other condition has been detected that required the braking or slowing of the host vehicle 101. This indicates that driver intervention should occur sooner rather than later. If the host vehicle 101 was not braking when the target drop occurred, this is a factor that may facilitate an increase in the threshold value, at block 450.

At block 420, the host vehicle 101 following distance d (FIG. 1) behind a target 140 at the time of target drop is examined. The lower the following distance d was, as indicated by the down arrow in FIG. 4, the lower the threshold may have to be set, at block 440. That is, the lower the following distance d (i.e., the closer the host vehicle 101 was to the target 140 at the time of target drop), the less time there may be to safely allow recovery of the sensor before requiring driver intervention. On the other hand, the higher the following distance d (i.e., the farther the host vehicle 101 was from the target 140 at the time of target drop), as indicated by the up arrow in FIG. 4, the more time there may be to safely allow recovery of the sensor before requiring driver intervention. Thus, this may promote an increase in the threshold value, at block 450, as indicated.

At block 430, the host vehicle 101 speed at the time of target drop is examined. The faster the speed of the host vehicle 101 was, the lower the threshold may have to be set, at block 440. That is, the faster the speed of the host vehicle 101, as indicated by the up arrow in FIG. 4, the less time there may be to safely allow recovery of the sensor before requiring driver intervention. On the other hand, the slower the speed of the host vehicle 101 at the time of target drop, as indicated by the down arrow in FIG. 4, the more time there may be to safely allow recovery of the sensor before requiring driver intervention. Thus, this factor promotes an increase in the threshold value at block 450, as indicated in FIG. 4.

While the factors that affect the setting of the threshold used at block 230 (FIG. 2) are discussed, the mechanism by which the factors are used to generate a value for the threshold is not limited. For example, according to an exemplary embodiment, the threshold value may be determined using a two-dimensional look-up table or map created with values of following distance d along one dimension and speed values of the host vehicle 101 along the other dimension. According to another exemplary embodiment, an empirical approach may be used to determine the threshold value based on the factors discussed at blocks 410, 420, 430. According to still another exemplary embodiment, a rule-based approach may be used to map the factors examined at blocks 410, 420, and 430 to a threshold value. According to yet another embodiment, machine learning may be used to determine the threshold according to the factors.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of confirming and mitigating a malfunction of a sensor used for adaptive cruise control (ACC) in a vehicle, the method comprising:
identifying the malfunction of the sensor;
determining a counter threshold value that defines a duration for which recovery of the sensor is awaited;
performing an iterative process to determine if the sensor has recovered, wherein a number of iterations of the iterative process is determined by the counter threshold value;
confirming the malfunction of the sensor based on the number of iterations exceeding the counter threshold value without a determination that the sensor has recovered; and
inhibiting the ACC based on the confirming the malfunction.

2. The method according to claim 1, further comprising resuming the ACC based on determining that the sensor has recovered prior to the number of iterations exceeding the counter threshold value.

3. The method according to claim 1, further comprising resuming the ACC based on determining that the sensor has recovered after the number of iterations exceeds the counter threshold value.

4. The method according to claim 1, further comprising disabling acceleration of the vehicle as part of the ACC prior to performing the iterative process.

5. The method according to claim 1, wherein the determining the counter threshold value is based on whether the vehicle was braking when the malfunction of the sensor was identified.

6. The method according to claim 1, wherein the determining the counter threshold value is based on a distance between the vehicle and a target vehicle in front of the vehicle when the malfunction of the sensor was identified.

7. The method according to claim 1, wherein the determining the counter threshold value is based on a speed of the vehicle when the malfunction of the sensor was identified.

8. The method according to claim 1, further comprising performing a second iterative process to determine if the sensor has recovered, wherein a number of iterations of the second iterative process is determined based on a speed of the vehicle when the malfunction of the sensor was identified.

9. The method according to claim 8, further comprising ending inhibition of the ACC based on the sensor recovering during the second iterative process.

10. The method according to claim 8, further comprising ending inhibition of the ACC based on the second iterative process ending.

11. A system to confirm and mitigate a malfunction of a sensor used for adaptive cruise control (ACC) in a vehicle, the system comprising:
the sensor configured to detect an object in front of the vehicle; and
a processor configured to identify the malfunction of the sensor, to determine a counter threshold value that defines a duration for which recovery of the sensor is awaited, to perform an iterative process to determine if the sensor has recovered, wherein a number of iterations of the iterative process is determined by the counter threshold value, to confirm the malfunction of the sensor based on the number of iterations exceeding the counter threshold value without a determination that the sensor has recovered, and to inhibit the ACC based on confirming the malfunction.

12. The system according to claim 11, wherein the processor is further configured to resume the ACC based on determining that the sensor has recovered prior to the number of iterations exceeding the counter threshold value.

13. The system according to claim 11, wherein the processor is further configured to resume the ACC based on determining that the sensor has recovered after the number of iterations exceeds the counter threshold value.

14. The system according to claim 11, wherein the processor is further configured to disable acceleration of the vehicle as part of the ACC prior to performing the iterative process.

15. The system according to claim 11, wherein the processor is configured to determine the counter threshold value based on whether the vehicle was braking when the malfunction of the sensor was identified.

16. The system according to claim 11, wherein the processor is configured to determine the counter threshold value based on a distance between the vehicle and a target vehicle in front of the vehicle when the malfunction of the sensor was identified.

17. The system according to claim 11, wherein the processor is configured to determine the counter threshold value based on a speed of the vehicle when the malfunction of the sensor was identified.

18. The system according to claim 11, wherein the processor is further configured to perform a second iterative process to determine if the sensor has recovered and determine a number of iterations of the second iterative process based on a speed of the vehicle when the malfunction of the sensor was identified.

19. The system according to claim 18, wherein the processor is further configured to end inhibition of the ACC based on the sensor recovering during the second iterative process or based on the second iterative process ending.

20. The system according to claim 11, wherein the sensor is a camera.
